(19) United States
(12) Patent Application Publication
(10) Pub. No.: US 2010/0323043 A1
(43) Pub. Date: Dec. 23, 2010

(54) Antimicrobial Compositions and Methods of Making and Using the Same

(76) Inventors: Marc D. Perla, Atlanta, GA (US); Eric V. Salo, Atlanta, GA (US); Eric H. Ritcher, Norcross, GA (US)

Correspondence Address: WITHERS & KEYS, LLC, P. O. BOX 2049, MCDONOUGH, GA, 30253, US

(21) Appl. No.: 12/490,214

(22) Filed: Jun. 23, 2009

(51) Int. Cl. A01N 65/08; A01N 43/02

(52) U.S. Cl. 424/736; 514/54

(57) ABSTRACT

Antimicrobial (e.g., moldicide, fungicide, and bacteriacide) compositions are disclosed. Methods of making and using antimicrobial (e.g., moldicide, fungicide, and bacteriacide) compositions are also disclosed.

### FIELD OF THE INVENTION

The present invention relates generally to antimicrobial (e.g., moldicide, fungicide, and bacteriacide) compositions. The present invention further relates to methods of making and using antimicrobial compositions.

### BACKGROUND OF THE INVENTION

There is a need in the art for effective antimicrobial compositions that are more environmentally friendly.

### SUMMARY OF THE INVENTION

The present invention is directed to antimicrobial (e.g., moldicide, fungicide, and bacteriacide) compositions. The antimicrobial compositions comprise a combination of ingredients resulting in antimicrobial compositions having exceptional mold inhibition, fungi inhibition, and/or bacteria inhibition properties, wherein the antimicrobial compositions are free of materials typically found in conventional antimicrobial (e.g., moldicide, fungicide, and bacteriacide) compositions.

Accordingly, the present invention is directed to antimicrobial (e.g., moldicide, fungicide, and bacteriacide) compositions. In one exemplary embodiment of the present invention, the antimicrobial compositions comprise water, ethanol, and at least one citrus extract complex compound, wherein the antimicrobial composition is a uniform mixture without phase separation of components into a liquid phase and a solid phase. The antimicrobial compositions of the present invention may further comprise a number of additional components in order to provide a particular composition property (e.g., additional anti-fungal properties, additional anti-bacterial properties, disinfecting properties, cleaning properties, product stability, etc.) to a given antimicrobial composition.

In a further exemplary embodiment of the present invention, the antimicrobial composition of the present invention comprises (or consists essentially of, or consists of) a mixture of water; ethanol; at least one citrus extract complex compound, wherein the at least one citrus extract complex compound comprises (or consists essentially of, or consists of) (i) citrus medica limonum extract, (ii) a complex compound comprising (or consisting essentially of, or consisting of) ascorbic acid, citric acid, citric pectin, and citrus bioflavonoid, (iii) a complex compound comprising (or consisting essentially of, or consisting of) one or more limonoid glucosides and one or more bioflavonoids, or (iv) any combination of (i) to (iii); an optional amount of potassium sorbate; an optional surfactant, the optional surfactant comprising (or consisting essentially of, or consisting of) a sodium lauryl sulfate, an alkyl polyglucopon, or a combination thereof; an optional complexing agent, the optional complexing agent comprising (or consisting essentially of, or consisting of) tetrasodium iminodisuccinate; an optional amount of glycerin; an optional buffer system, the optional buffer system comprising (or consisting essentially of, or consisting of) sodium citrate and citric acid; an optional inhibitor, the optional inhibitor comprising (or consisting essentially of, or consisting of) 2-phosphonobutane-1,2,4-tricarboxylic acid; and an optional dispersing agent, the optional dispersing agent comprising (or consisting essentially of, or consisting of) sodium polyaspartate; wherein the antimicrobial composition is a uniform mixture without phase separation of components into a liquid phase and a solid phase.

The present invention is also directed to methods of making antimicrobial compositions. In one exemplary embodiment of the present invention, the method of making a antimicrobial composition comprises the steps of adding one or more composition components to water, and mixing the resulting antimicrobial composition.

The present invention is further directed to methods of using the disclosed antimicrobial compositions. In one exemplary embodiment of the present invention, the method of using the disclosed antimicrobial composition comprises the step of spraying, wiping, brushing, and/or dipping a surface of an object that needs cleaning and/or protecting. Suitable surfaces include, but are not limited to, hard surfaces.

These and other features and advantages of the present invention will become apparent after a review of the following detailed description of the disclosed embodiments and the appended claims.

### DETAILED DESCRIPTION OF THE INVENTION

The present invention is directed to antimicrobial compositions. As used herein, the term “antimicrobial compositions” includes, but is not limited to, moldicide, fungicide, and bacteriacide compositions. The present invention is further directed to methods of making and using antimicrobial compositions.

The antimicrobial compositions of the present invention may comprise a number of components. A description of individual components and combinations of individual components is provided below.

### I. Antimicrobial Composition Components

The antimicrobial compositions of the present invention may comprise one or more of the following components.

A. Water

The antimicrobial compositions of the present invention comprise water. Soft or hard water may be used in the present invention, although soft water is more desirable. As used herein, the term “soft water” refers to water containing less than about 60 ppm of water hardness expressed as calcium carbonate content. As used herein, the term “hard water” refers to water containing more than about 60 ppm of water hardness expressed as calcium carbonate content, while “very hard water” refers to water containing more than about 180 ppm of water hardness expressed as calcium carbonate content. The antimicrobial compositions of the present invention may be formed using water available from any municipal water-treatment facility.

In one exemplary embodiment, the antimicrobial compositions of the present invention are prepared by filtering the water using any one or a combination of the following methods: ion exchange, adsorption, distillation, flocculation, membrane filtration, and reverse osmosis.

The antimicrobial compositions of the present invention typically comprise greater than about 84 weight percent (wt %) of water (desirably filtered water) based on a total weight of a given antimicrobial composition. In exemplary embodiments, the antimicrobial compositions of the present invention comprise greater than about 90 wt % (or greater than about 91 wt %, or greater than about 93 wt %, or greater than about 95 wt %, or greater than about 96 wt %, or greater than about 98 wt %) of water (desirably filtered water) based on a total weight of a given antimicrobial composition. Desirably, the antimicrobial compositions of the present invention comprise from about 92 to about 95 wt % water (more desirably filtered water) based on a total weight of a given antimicrobial composition.

B. Citrus Extract Complex Compound

The antimicrobial compositions of the present invention comprise at least one citrus extract complex compound. As used herein, the term “citrus extract complex compound” is used to describe a composition comprising one or more components derived from a citrus fruit (e.g., the peel of a citrus fruit). Suitable citrus extract complex compounds include, but are not limited to, (i) citrus medica limonum extract (i.e., lemon extract that does not include grapefruit and is not derived from grapefruit), (ii) citrus limonum extract (i.e., lemon extract that does not include grapefruit and is not derived from grapefruit), (iii) a complex compound comprising ascorbic acid, citric acid, citric pectin, and citrus bioflavonoid, (iv) a complex compound comprising one or more limonoid glucosides and one or more bioflavonoids, or (v) any combination of (i) to (iv). Suitable citrus extract complex compounds include, but are not limited to, a citrus extract having CAS number 977038-62-2, which is a citrus medica limonum extract that does not include grapefruit and is not derived from grapefruit.

Each of the one or more citrus extract complex compounds may independently be present in a given antimicrobial composition in an amount of up to about 2.5 weight percent (wt %) based on a total weight of the antimicrobial composition. Typically, each of the one or more citrus extract complex compounds is independently present in a given antimicrobial composition in an amount ranging from about 0.1 to about 2.0 wt %, more desirably from about 0.1 to about 1.0 wt %, even more desirably from about 0.25 to about 0.75 wt % based on a total weight of the antimicrobial composition.

A number of commercially available citrus extract complex compounds may be used in the present invention. Suitable commercially available citrus extract complex compounds include, but are not limited to, BIOSECUR 160S® citrus extract complex compound, BIOSECUR 160S/162S® citrus extract complex compound, and BIOSECUR 162™ citrus extract complex compound, all of which are commercially available from BioSecur Lab, Inc. (Quebec, Canada).

C. Ethanol

The antimicrobial compositions of the present invention may further comprise ethanol. Suitable ethanol includes, but is not limited to, ethanol having a CAS number 64-17-5.

Ethanol may be present in a given antimicrobial composition in an amount of up to about 5.0 weight percent (wt %) based on a total weight of the antimicrobial composition. Typically, ethanol is present in a given antimicrobial composition in an amount ranging from about 1.0 to about 5.0 wt %, more desirably from about 2.0 to about 5.0 wt %, even more desirably from about 1.5 to about 4.0 wt % based on a total weight of the antimicrobial composition.

Ethanol suitable for use in the antimicrobial compositions of the present invention is commercially available under the trade designations EVERCLEAR™ and GOLDEN GRAIN™ Alcohols, all of which are commercially available from Luxco, Inc. (St. Louis, Mo.).

D. Potassium Sorbate, FCC Grade

The antimicrobial compositions of the present invention may further comprise potassium sorbate. Suitable potassium sorbates include, but are not limited to, potassium sorbate having CAS number 24634-61-5. When present, potassium sorbate may be present in a given antimicrobial composition in an amount of up to about 4.0 weight percent (wt %) based on a total weight of the antimicrobial composition. Typically, when present, potassium sorbate is present in a given antimicrobial composition in an amount ranging from about 0.1 to about 4.0 wt %, more desirably from about 1.0 to about 4.0 wt %, and even more desirably from about 3.0 to about 4.0 wt % based on a total weight of the antimicrobial composition.

Potassium sorbate suitable for use in the antimicrobial compositions of the present invention is commercially available from a number of sources including, but not limited to, Baddley Chemicals, Inc. (Baton Rouge, La.).

E. Surfactants

The antimicrobial compositions of the present invention may further comprise one or more surfactants, desirably plant derived surfactants. Suitable surfactants include, but are not limited to, sodium lauryl sulfates such as sodium lauryl sulfates having a CAS number 151-21-3; alkyl polyglucopons such as alkyl polyglucopon having CAS number 68515-73-1, alkyl polyglucopons having CAS number 110615-47-9, or any combination thereof; and any combination of a sodium lauryl sulfate and an alkyl polyglucopon.

In one exemplary embodiment, the antimicrobial compositions of the present invention comprise a sodium lauryl sulfate. In another exemplary embodiment, the antimicrobial compositions of the present invention comprise an alkyl polyglucopon. In yet another exemplary embodiment, the antimicrobial compositions of the present invention comprise a sodium lauryl sulfate and an alkyl polyglucopon.

When present, each surfactant may be independently present in a given antimicrobial composition in an amount of up to about 2.0 weight percent (wt %) based on a total weight of the antimicrobial composition. Typically, when present, each surfactant is independently present in a given antimicrobial composition in an amount ranging from about 0.1 to about 2.0 wt %, more desirably from about 0.5 to about 2.0 wt %, and even more desirably from about 0.5 to about 1.5 wt % based on a total weight of the antimicrobial composition.

A number of commercially available surfactants may be used in the present invention. Suitable commercially available surfactants include, but are not limited to, sodium lauryl sulfates sold under the trade designations CALFOAM® SLS-30 and CALFOAM® SLS-95, both of which are commercially available from Pilot Chemical Co. (Red Bank, N.J.); and alkyl glucosides sold under the trade designations GLUCOPON® 215UP, GLUCOPON® 225DK, GLUCOPON® 425, GLUCOPON® 600UP, and GLUCOPON® 625UP, all of which are commercially available from Cognis Corporation (Cincinnati, Ohio).

F. Glycerin, USP, Kosher Grade

The antimicrobial compositions of the present invention may further comprise glycerin derived from a vegetable source. Suitable glycerin may include, but is not limited to, glycerin having CAS number 56-81-5.

When present, glycerin is typically present in a given antimicrobial composition in an amount of up to about 2.0 weight percent (wt %) based on a total weight of the antimicrobial composition. Typically, when present, glycerin is present in a given antimicrobial composition in an amount ranging from about 0.2 to about 4.0 wt %, more desirably from about 0.25 to about 2.0 wt %, even more desirably from about 0.25 to about 1.0 wt % based on a total weight of the antimicrobial composition.

A number of commercially available glycerins may be used in the present invention. Suitable commercially available glycerins include, but are not limited to, EMERY® 917 commercially available from Cognis Oleochemicals, LLC (Cincinnati, Ohio). In addition, at least some of the above-described commercially available citrus extract complex compounds, such as BIOSECUR 160S® citrus extract complex compound, already contain vegetable glycerin.

G. Complexing Agents

The antimicrobial compositions of the present invention may further comprise one or more complexing agents. Suitable complexing agents include, but are not limited to, tetrasodium iminodisuccinate such as tetrasodium iminodisuccinate having CAS number 144538-83-0.

When present, each complexing agent may be independently present in a given antimicrobial composition in an amount of up to about 3.0 weight percent (wt %) based on a total weight of the antimicrobial composition. Typically, when present, each complexing agent is independently present in a given antimicrobial composition in an amount ranging from about 0.2 to about 3.0 wt %, more desirably from about 0.5 to about 3.0 wt %, even more desirably from about 1.0 to about 3.0 wt % based on a total weight of the antimicrobial composition.

A number of commercially available complexing agents may be used in the present invention. Suitable commercially available complexing agents include, but are not limited to, BAYPURE® CX100 commercially available from LANXESS Corporation (Pittsburgh, Pa.).

H. Dispersing Agents

The antimicrobial compositions of the present invention may comprise one or more dispersing agents. Suitable dispersing agents include, but are not limited to, sodium polyaspartate such as sodium polyaspartate having CAS number 181828-06-8.

When present, each dispersing agent is typically present in a given antimicrobial composition in an amount of up to about 2.0 weight percent (wt %) based on a total weight of the antimicrobial composition. Typically, when present, each dispersing agent is independently present in a given antimicrobial composition in an amount ranging from about 0.5 to about 2.0 wt %, and more desirably from about 0.5 to about 1.0 wt % based on a total weight of the antimicrobial composition.

A number of commercially available dispersing agents may be used in the present invention. Suitable commercially available dispersing agents include, but are not limited to, BAYPURE® DS100 commercially available from LANXESS Corporation (Pittsburgh, Pa.).

### I. Buffer Systems

The antimicrobial compositions of the present invention may further comprise one or more buffer systems. Suitable buffer systems include, but are not limited to, a buffer system comprising sodium citrate and citric acid, for example, in the ratio of about 18.5 sodium citrate to about 1 citric acid. Suitable buffer system components may include sodium citrate having CAS number 6132-04-3, citric acid having CAS number 77-92-9, or any combination thereof.

When present, the buffer system may be present in a given antimicrobial composition in an amount of up to about 6.5 weight percent (wt %) based on a total weight of the antimicrobial composition. Typically, when present, the buffer system is present in a given antimicrobial composition in an amount ranging from about 2.1 to about 6.5 wt %, more desirably from about 2.1 to about 4.8 wt %, and even more desirably from about 3.7 to about 4.2 wt % based on a total weight of the antimicrobial composition.

A number of commercially available buffer system components may be used in the present invention. Suitable commercially available buffer system components include, but are not limited to, sodium citrate USP/FCC Grade and citric acid USP/FCC Grade, both of which are commercially available from DuPont Tate & Lyle BioProducts (Wilmington, Del.).

J. Inhibitors

The antimicrobial compositions of the present invention may further comprise one or more inhibitors. Suitable inhibitors include, but are not limited to, 2-phosphonobutane-1,2,4-tricarboxylic acid such as 2-phosphonobutane-1,2,4-tricarboxylic acid having CAS number 37971-36-1.

When present, each inhibitor is typically present in a given composition in an amount of up to about 0.5 weight percent (wt %) based on a total weight of the antimicrobial composition. Typically, when present, each inhibitor is present independently in a given antimicrobial composition in an amount ranging from greater than 0 to about 1.0 wt %, more desirably from about 0.1 to about 0.8 wt %, and even more desirably from about 0.1 to about 0.5 wt % based on a total weight of the antimicrobial composition.

A number of commercially available inhibitors may be used in the present invention. Suitable commercially available inhibitors include, but are not limited to, BAYHIBIT™ AM commercially available from LANXESS Corporation (Pittsburgh, Pa.).

### II. Methods of Making Antimicrobial Compositions

The present invention is further directed to methods of making the above-described antimicrobial compositions. In one exemplary embodiment of the present invention, the method of making a given antimicrobial composition comprises the steps of adding one or more of the above-described composition components to water, and mixing the resulting composition. In some exemplary embodiments, the method of making a given antimicrobial composition comprises the steps of adding one or more of the above-described composition components to water, and mixing the resulting composition so that the resulting composition consists essentially of water and one or more of the above-described composition components. In other exemplary embodiments, the method of making a given antimicrobial composition comprises the steps of adding one or more of the above-described composition components to water, and mixing the resulting composition so that the resulting composition consists of water and one or more of the above-described composition components.

Methods of making a given antimicrobial composition may further comprise one or more additional method steps including, but not limited to, weighing one or more composition components prior to adding the composition component to water, blending, packaging the antimicrobial composition in a container (e.g., a non-pressurized spray bottle, a bulk plastic container, etc.), and offering for sale the antimicrobial composition.

### III. Methods of Using Antimicrobial Compositions

The present invention is further directed to methods of using the above-described antimicrobial compositions. In one exemplary embodiment of the present invention, the method of using an antimicrobial composition comprises the step of spraying, wiping, brushing, and/or dipping a surface of an object that needs cleaning and/or protecting with an antimicrobial composition of the present invention.

In some exemplary embodiments of the present invention, the method of using an antimicrobial composition comprises the step of spraying and wiping kitchen countertops and floors for surface disinfection (e.g., removal and/or prevention of Bacillus cereus, Staphylococcus aureus, Stenotrophomonas maltophilia, and/or Serattia). In other exemplary embodiments of the present invention, the method of using an antimicrobial composition comprises the step of spraying and washing fruits and vegetables for disinfection (e.g., removal and/or prevention of Bacillus cereus, Staphylococcus aureus, Stenotrophomonas maltophilia, and/or Serattia). In other exemplary embodiments of the present invention, the method of using an antimicrobial composition comprises the step of wetting ceiling tile, a wallboard surface, and/or a raw wood surface with an antimicrobial composition of the present invention, and allowing the ceiling tile, a wallboard surface, and/or a raw wood surface to dry so as to form a protective coating on the ceiling tile, a wallboard surface, and/or a raw wood surface to prevent mold and/or mildew (e.g., removal and/or prevention of Candida albicans, mucor racemosus, Aspergillums' niger). In yet other exemplary embodiments of the present invention, the method of using an antimicrobial composition comprises the step of brushing tile, grout, brick, and/or stone with an antimicrobial composition of the present invention to remove and prevent mold (e.g., removal and/or prevention of Candida albicans, mucor racemosus, Aspergillums' niger).

The present invention is described above and further illustrated below by way of examples, which are not to be construed in any way as imposing limitations upon the scope of the invention. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLE 1

### Preparation of Antimicrobial Compositions

Exemplary antimicrobial compositions of the present invention were prepared using components shown in Table 1 below.

TABLE 1
Antimicrobial Composition Components Used in Example

| Component | Source | Component Class |
|---|---|---|
| filtered water | municipal | solvent |
| BIOSECUR 160S ® | BioSecur Lab, Inc. | citrus extract |
| | (Quebec, Canada) | complex compound |
| ethanol | Luxco, Inc. (St. Louis, | solvent |
| | MO) | |
| potassium sorbate | Baddley Chemicals, Inc. | potassium sorbate |
| | (Baton Rouge, LA) | |
| CALFOAM ® SLS-30 | Pilot Chemical Co. (Red | surfactant |
| | Bank, NJ | |
| GLUCOPON ® 600UP | Cognis Corporation | surfactant |
| | (Cincinnati, OH) | |
| EMERY ® 917 | Cognis Oleochemicals, | glycerin |
| | LLC (Cincinnati, OH) | |
| BAYPURE ® CX100 | LANXESS Corporation | complexing agent |
| (tetrasodium | (Pittsburgh, PA) | |
| iminodisuccinate) | | |
| BAYPURE ® DS100 | LANXESS Corporation | dispersing agent |
| | (Pittsburgh, PA) | |
| sodium citrate | Dupont Tate & Lyle Bio | buffer system |
| USP/FCC Grade | Products (Wilmington, | component |
| | DE | |
| citric acid | Dupont Tate & Lyle Bio | buffer system |
| USP/FCC Grade | Products (Wilmington, | component |
| | DE | |
| BAYHIBIT ™ AM | LANXESS Corporation | inhibitor |
| (2-phosphonobutane- | (Pittsburgh, PA) | |
| 1,2,4-tricarboxylic acid) | | |

In the preparation of each antimicrobial composition, one or more composition components from Table 1 were added to water while mixing. Resulting antimicrobial compositions are provided in Tables 2-3 below.

TABLE 2
Sample Antimicrobial Compositions

| | Sample | | | | | | | | | | | | | | |
|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 |
| Component | weight percent (wt %) | | | | | | | | | | | | | | |
| filtered water | 92.85 | 93.80 | 93.75 | 97.40 | 96.45 | 91.50 | 93.75 | 92.65 | 91.50 | 90.90 | 93.70 | 92.95 | 91.00 | 89.00 | 85.40 |
| BIOSECUR | 0.15 | 0.20 | 0.25 | 0.10 | 0.30 | 1.0 | 0.25 | 0.35 | 0.50 | 2.00 | 0.30 | 0.25 | 0.10 | 0.20 | 0.40 |
| 160S ® | | | | | | | | | | | | | | | |
| ethanol | 5.0 | 3.0 | 2.0 | 1.0 | 0.5 | 2.5 | 2.0 | 3.0 | 4.0 | 2.0 | 1.5 | 1.0 | 3.0 | 4.0 | 5.0 |
| potassium sorbate | 2.0 | 3.0 | 4.0 | 1.0 | 2.0 | 3.5 | 3.0 | 2.0 | 1.0 | 0.3 | 0.5 | 0.1 | 0.5 | 1.0 | 1.5 |
| CALFOAM ® | | | | | | | | | | | | | 0.2 | 0.5 | 1.0 |
| SLS-30 | | | | | | | | | | | | | | | |
| GLUCOPON ® | | | | 0.50 | 0.75 | 1.5 | | | | | 0.1 | | | | |
| 600UP | | | | | | | | | | | | | | | |
| EMERY ® 917 | | | | | | | | | | 0.5 | | 2.0 | 1.0 | 0.5 | 0.2 |
| BAYPURE ® | | | | | | | 1.0 | 2.0 | 3.0 | | | | | | |
| CX100 | | | | | | | | | | | | | | | |
| (tetrasodium | | | | | | | | | | | | | | | |
| iminodisuccinate) | | | | | | | | | | | | | | | |
| sodium citrate | | | | | | | | | | 4.08 | 3.70 | 3.51 | 3.98 | 4.55 | 6.17 |
| USP/FCC Grade | | | | | | | | | | | | | | | |
| citric acid | | | | | | | | | | 0.22 | 0.20 | 0.19 | 0.22 | 0.25 | 0.33 |
| USP/FCC Grade | | | | | | | | | | | | | | | |

TABLE 3
Sample Antimicrobial Compositions

| | Sample | | | | | |
|---|---|---|---|---|---|---|
| | 16 | 17 | 18 | 19 | 20 | 21 |
| Component | weight percent (wt %) | | | | | |
| filtered water | 91.50 | 94.25 | 94.20 | 91.00 | 94.50 | 97.00 |
| BIOSECUR 160S ® | 1.0 | 0.5 | 2.5 | 1.0 | 0.5 | 0.25 |
| ethanol | 4.0 | 3.0 | 2.0 | 3.0 | 2.0 | 1.0 |
| GLUCOPON ® 600UP | 2.0 | 1.5 | 1.0 | 2.0 | 1.5 | 1.0 |
| EMERY ® 917 | | | | 1.0 | 0.5 | 0.25 |
| BAYPURE ® CX100 | 1.0 | 0.5 | 0.2 | | | |
| (tetrasodium | | | | | | |
| iminodisuccinate) | | | | | | |
| BAYPURE ® DS100 | | | | 2.0 | 1.0 | 0.5 |
| BAYHIBIT ™ AM | 0.5 | 0.25 | 0.10 | | | |
| (2-phosphonobutane- | | | | | | |
| 1,2,4-tricarboxylic acid) | | | | | | |

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. An antimicrobial composition comprising a mixture of:
water;
ethanol; and
at least one citrus extract complex compound;
said antimicrobial composition being a uniform mixture without phase separation of components into a liquid phase and a solid phase.

2. The antimicrobial composition of claim 1, wherein said at least one citrus extract complex compound comprises (i) a citrus medica limonum extract, (ii) a complex compound comprising ascorbic acid, citric acid, citric pectin, and citrus bioflavonoid, (iii) a complex compound comprising one or more limonoid glucosides and one or more bioflavonoids, or (iv) any combination of (i) to (iii).

3. The antimicrobial composition of claim 2, wherein said at least one citrus extract complex compound comprises a citrus extract that does not include grapefruit and is not derived from grapefruit.

4. The antimicrobial composition of claim 4, wherein said antimicrobial composition further comprises:
potassium sorbate.

5. The antimicrobial composition of claim 1, wherein said antimicrobial composition further comprises:
a surfactant, said surfactant comprising a sodium lauryl sulfate, an alkyl polyglucopon, or a combination thereof.

6. The antimicrobial composition of claim 4, wherein said antimicrobial composition further comprises:
a surfactant, said surfactant comprising a sodium lauryl sulfate, an alkyl polyglucopon, or a combination thereof.

7. The antimicrobial composition of claim 4, wherein said antimicrobial composition further comprises:
a complexing agent, said complexing agent comprising tetrasodium iminodisuccinate.

8. The antimicrobial composition of claim 5, wherein said antimicrobial composition further comprises:
a complexing agent, said complexing agent comprising tetrasodium iminodisuccinate.

9. The antimicrobial composition of claim 4, wherein said antimicrobial composition further comprises:
glycerin.

10. The antimicrobial composition of claim 5, wherein said antimicrobial composition further comprises:
glycerin.

11. The antimicrobial composition of claim 6, wherein said antimicrobial composition further comprises:
glycerin.

12. The antimicrobial composition of claim 9, wherein said antimicrobial composition further comprises:
a buffer system, said buffer system comprising sodium citrate and citric acid.

13. The antimicrobial composition of claim 11, wherein said antimicrobial composition further comprises:
a buffer system, said buffer system comprising sodium citrate and citric acid.

14. The antimicrobial composition of claim 8, wherein said antimicrobial composition further comprises:
an inhibitor, said inhibitor comprising 2-phosphonobutane-1,2,4-tricarboxylic acid.

15. The antimicrobial composition of claim 10, wherein said antimicrobial composition further comprises:
a dispersing agent, said dispersing agent comprising sodium polyaspartate.

16. An antimicrobial composition consisting essentially of a mixture of:
water;
ethanol;
a citrus extract complex compound consisting essentially of a citrus medica limonum extract that does not include grapefruit and is not derived from grapefruit;
potassium sorbate;
an optional surfactant, said optional surfactant consisting essentially of a sodium lauryl sulfate, an alkyl polyglucopon, or a combination thereof;
an optional amount of glycerin; and
an optional buffer system, said optional buffer system consisting essentially of sodium citrate and citric acid;
said antimicrobial composition being a uniform mixture without phase separation of components into a liquid phase and a solid phase.

17. The antimicrobial composition of claim 16, wherein said antimicrobial composition consisting essentially of a mixture of:
from about 92 to about 95 wt % water;
from about 1.5 to about 4.0 wt % ethanol;
from about 0.25 to about 0.75 wt % citrus extract complex compound; and
from about 0.1 to about 4.0 wt % potassium sorbate.

18. The antimicrobial composition of claim 16, wherein said antimicrobial composition consisting essentially of a mixture of:
water;
ethanol;
a citrus extract complex compound consisting essentially of a citrus medica limonum extract that does not include grapefruit and is not derived from grapefruit;
potassium sorbate;
an alkyl polyglucopon surfactant;
glycerin; and
a buffer system, said buffer system consisting essentially of sodium citrate and citric acid at a 18.5:1 ratio.

19. The antimicrobial composition of claim 18, wherein said antimicrobial composition consisting essentially of a mixture of:
from about 92 to about 95 wt % water;
from about 1.5 to about 4.0 wt % ethanol;
from about 0.25 to about 0.75 wt % citrus extract complex compound; and
from about 0.1 to about 4.0 wt % potassium sorbate;
from about 0.1 to about 1.5 wt % alkyl polyglucopon surfactant;
from about 0.2 to about 4.0 wt % glycerin; and
from about 2.1 to about 4.8 wt % buffer system.

20. An antimicrobial composition consisting essentially of a mixture of:
water;
ethanol;
a citrus extract complex compound consisting essentially of a citrus medica limonum extract that does not include grapefruit and is not derived from grapefruit;
potassium sorbate;
a sodium lauryl sulfate, an alkyl polyglucopon, or a combination thereof;
an optional complexing agent, said optional complexing agent consisting essentially of tetrasodium iminodisuccinate;
glycerin;
a buffer system, said buffer system consisting essentially of sodium citrate and citric acid at a 18.5:1 ratio;
an optional inhibitor, said optional inhibitor consisting essentially of 2-phosphonobutane-1,2,4-tricarboxylic acid; and
an optional dispersing agent, said optional dispersing agent consisting essentially of sodium polyaspartate;
said antimicrobial composition being a uniform mixture without phase separation of components into a liquid phase and a solid phase.
